(19) United States
(12) Patent Application Publication
(10) Pub. No.: US 2025/0200257 A1
(43) Pub. Date: Jun. 19, 2025

(54) DATA PATH ELEMENTS FOR IMPLEMENTATION OF COMPUTATIONAL LOGIC USING DIGITAL VLSI SYSTEMS

(71) Applicant: Uma Pandey, Hamirpur (IN)

(72) Inventors: Kumar Sambhav Pandey, Hamirpur (IN); Hitesh SHRIMALI, Mandi (IN)

(21) Appl. No.: 18/878,663

(22) PCT Filed: May 25, 2023
(86) PCT No.: PCT/IN2023/050499

§ 371 Date: Dec. 24, 2024

(30) Foreign Application Priority Data
May 25, 2022 (IN) 202211030038

(51) Int. Cl. G06F 30/327

(52) U.S. Cl. CPC G06F 30/327

(57) ABSTRACT

Data path elements implemented using a plurality of logic primitives are provided. The plurality of logic primitives are connected in one or more topologies to perform an atomic operation on at least two atomic input data of a pre-defined bit-size. The atomic operation is split into a plurality of sub-atomic operations and the at least two atomic input data is split into a plurality of sub-atomic data fragments. Each of the plurality of logic primitives perform a sub-atomic operation from the plurality of sub-atomic operations on at least two sub-atomic data fragments from the plurality of sub-atomic data fragments to generate at least one partial sub-atomic output data. The at least one partial sub-atomic output data is generated based on a partial arithmetic operation, a shift operation, or a logical operation performed by each of the plurality of logic primitives in each clock-cycle. The architectures of a plurality of data-path elements comprised of a plurality of logic primitives in a plurality of connection topologies are provided.

### CROSS-REFERENCE INFORMATION

This application is a national phase of Indian PCT Application No. PCT/IN2023/050499 titled “DATA PATH ELEMENTS FOR IMPLEMENTATION OF COMPUTATIONAL LOGIC USING DIGITAL VLSI SYSTEMS” which claims priority to the Indian provisional patent application No. 202211030038, filed May 25, 2022, entitled “IMPLEMENTATION OF DIGITAL INTEGRATED CIRCUITS ORGANIZED AS SUBSCALAR ARCHITECTURES COMPOSED OF MICRO-CELL LIBRARY BLOCKS” both of which are hereby incorporated by reference in its entirety.

### TECHNICAL FIELD

The instant disclosure relates to a method and system for designing ASIC (application specific integrated circuit) implementing computational logic in very large scale integrated (VLSI) system.

### BACKGROUND

In semiconductor design, standard-cell methodology is used to design application-specific integrated circuits (ASICs) with mostly pre laid out digital-logic gates. Standard-cell methodology is an example of design abstraction, whereby a low level very-large-scale integration (VLSI) layout is encapsulated into an abstract logic representation (such as a NAND gate). Using standard-cell methodology, ASICs have been scaled from comparatively simple single-function ICs (of several thousand gates), to complex multi-million gate system-on-a-chip (SoC) devices which are used in personal computers, graphic cards, digital cameras, smart devices, etc. These computing structures implement computational logic which are implemented using a number of transistors. Their processing throughput depends greatly on the computational logic and the number of transistors being used. Further, parallelism is one of the key mechanisms for enhancing the processing throughput. It is known in the art that the presence of data-flow dependencies adversely impacts the exploitation of such parallelism. The performance of digital systems cannot be arbitrarily enhanced merely by way of exploiting parallelism at data-word boundaries in presence of such data-flow dependencies. A deeper inspection and research on the architectures of arithmetic computing structures, reveal that neither all the bits of the result are produced simultaneously nor do all the bits of operands are consumed simultaneously in any logical operation. Further, some implementations in prior art, operate on operands with less precision in order to be faster and to consume less silicon resources by way of compromising on data width in one way or the other.

In prior art ASICs are designed using EDA tools and resulting circuits are comprised of logic primitives chosen either from standard cell libraries or from pre laid out macro cells. Such primitives may also be chosen from microcell libraries which are at a higher abstraction than that of standard cells and lower than that of macro cells.

Therefore, there is a requirement to develop some useful data-path elements comprising of microcells which may help implement a computational methodology utilizing parallelism in a manner that is resource friendly and allows processing with higher efficiency and speed.

### SUMMARY

In an embodiment, data path element implemented using a plurality of microcells is provided. The plurality of microcells may be connected in one or more topologies to perform an atomic operation on at least two atomic input data of a pre-defined bit-size. In an embodiment, the atomic operation may be split into a plurality of sub-atomic operations and the at least two atomic input data may be split into a plurality of subatomic data fragments. In an embodiment, each of the plurality of microcells may perform a sub-atomic operation from the plurality of sub-atomic operations on at least two sub-atomic data fragments from the plurality of sub-atomic data fragments to generate at least one partial sub-atomic output data. In an embodiment, the at least one partial sub-atomic output data may be generated based on a partial arithmetic operation, a shift operation, or a logical operation performed by each of the plurality of microcells in each clock-cycle.

In an embodiment, the one or more topologies may include a serial topology, a parallel topology and/or a cascade topology. In an embodiment, the plurality of microcells may be connected in a serial topology by establishing at least one serial data path to output at least one partial sub-atomic output data from at least one preceding microcell of the plurality of microcells as input to at least one succeeding microcell of the plurality of microcells in a next clock-cycle.

In an embodiment, the plurality of microcells may be connected in a parallel topology by establishing at least two parallel data paths to output two partial subatomic output data each from two microcells from the plurality of microcells in parallel as input to at least two succeeding microcells of the plurality of microcells in the next clock clock-cycle.

In an embodiment, the plurality of microcells may be connected in a cascade topology by establishing at least two parallel data paths to output two partial subatomic output data each from at least one microcell from the plurality of microcells in parallel as input to at least one succeeding microcell of the plurality of microcells in a next clock-cycle.

In an embodiment, each of the plurality of microcells may be configured to perform one of a logic operation, a shift operation, a mask operation, a partial addition operation, a partial subtraction operation, a partial multiplication operation, a compare operation, a multiplexing operation, or a de-multiplexing operation.

In an embodiment, the data path element may be configured as an adder data path element to perform the atomic operation of an addition on the at least two atomic data. In an embodiment, the adder data path element may include at least two microcells, each performing a partial addition operation.

In an embodiment, the data path element may be configured as a subtractor data path element to perform the atomic operation of a subtraction on the at least two atomic data. In an embodiment, the subtractor data path element may comprise at least two microcells, each performing a partial subtraction operation.

In an embodiment, the data path element may be configured as a multiplier data path element to perform the atomic operation of a multiplication on the at least two atomic data. In an embodiment, the multiplier data path element may comprise at least four microcells, performing at least a partial multiply-add operation and/or a partial addition operation.

In an embodiment, the data path element may be configured as a bitwise logic data path element to perform the atomic operation of a bitwise logic on the at least two atomic data. In an embodiment, the bitwise logic data path element may comprise at least two or more microcells performing a logic operation. In an embodiment, the logic operation may be a bit-wise operations or a binary operation.

In an embodiment, the data path element may be configured as a bi-directional shifter data path element to perform the atomic operation of a bi-directional shift of the at least two sub-atomic data. In an embodiment, the bi-directional shifter may comprise at least one microcell performing a mask operation, at least two microcells each performing a bit-wise left shift operation, at least one microcell performing an OR operation, and at least one microcell performing a multiplexing operation.

In an embodiment, the data path element may be configured as a multiplexer data path element to perform the atomic operation of selecting one of the inputs from the at least two atomic data. In an embodiment, the multiplexer data path element may comprise at least two mux microcells, each performing a multiplexing operation.

In an embodiment, the data path element may be configured as a demultiplexer data path element to perform the atomic operation of steering the input to the at least two output paths. In an embodiment, the demultiplexer data path element may comprise at least two demux microcells, each performing a demultiplexing operation.

In an embodiment, the data path element may be configured as a comparator data path element to perform the atomic operation of compare on the at least two atomic data. In an embodiment, the comparator data path element may comprise at least two compare microcells, each configured to perform a compare operation, and one mask microcell may be configured to perform a mask operation.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, explain the disclosed principles.

FIG. 1 illustrates a microcell of a microcell library, in accordance with an embodiment of the present disclosure.

FIG. 2 illustrates an adder data path element, in accordance with an exemplary embodiment.

FIG. 3 illustrates a subtractor data path element, in accordance with an exemplary embodiment.

FIG. 4 illustrates a multiplier data path element, in accordance with an exemplary embodiment.

FIG. 5 illustrates a bitwise logic data path element, in accordance with an embodiment of the present disclosure.

FIG. 6 illustrates a bi-directional shifter data path element, in accordance with an embodiment of the present disclosure.

FIG. 7 illustrates a multiplexer data path element, in accordance with an embodiment of the present disclosure.

FIG. 8 illustrates a demultiplexer data path element, in accordance with an embodiment of the present disclosure.

FIG. 9 illustrates a comparator data path element, in accordance with an embodiment of the present disclosure.

FIG. 10A, FIG. 10B and FIG. 10C illustrates area-throughput figure-of-merit (FOM) for the unpipelined, pipelined, and subscalar implementations at pair, nibble, and byte valencies of the chosen benchmark circuits are plotted as histograms for an 8-bit, 16-bit, 32-bit data-path widths, in accordance with an experimental embodiment of the present disclosure.

### DETAILED DESCRIPTION

The present invention presents enabling various combinatorial topologies using a cell library at an abstraction that is higher than that of standard cells, but lower than macro cells.

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed below.

A subscalar operation operates on sub-atomic data fragments and performs only partial operations on them. The atomic data and atomic operations are broken down into sub-atomic data fragments and sub-atomic partial operations respectively. Such a break-up exposes hitherto unexploited levels of parallelism by way of allowing overlap of operations even if they are data dependent. Applicants have found that the improved exploitation of latent parallelism to enhance processing throughputs comes with a favourable impact on the area-power characteristics of corresponding computing structures. A number of these subscalar instructions are connected in series, parallel, cascade or compound topologies to perform an atomic operation on atomic data. As these subscalar operations or instructions operate on sub-atomic data fragments, even data-flow dependent operations may be temporally overlapped, thereby giving rise to a new and novel concept of sub-instruction level parallelism (sILP). Such atomic operations may be performed using a combination of microcells connected in one or more topologies such as, but not limited to series, parallel, cascade or compound topologies.

In a pipelined subatomic implementation, using a single instance of the implementation unit, the atomic operations may be computed by splitting each of the atomic operations into one or more sub-atomic operations. In an embodiment, an atomic operation may be split into sub-atomic operations based on a complexity level of the atomic operation and time required to perform each of the subatomic operations. Accordingly, one or more of the subatomic operations may be computed in one clock cycle and any atomic operation may be implemented using a combination of microcells connected in one or more topologies. Further, the computation of each atomic operation may be done by operating on their corresponding atomic input operands or atomic datum which may be split into two or more sub-word or sub-atomic data fragments. In an embodiment, the valency of the subatomic data fragment may be equal to 1 bit, 2 bit, 4 bit, 8 bit, 16 bit, 32 bit, and so on.

In an embodiment, the microcells may be defined as pre-configured logic primitives that may be connected in various combinations and topologies to create useful arithmetic and logic modules like adders, shifters, multiplexers, comparators, etc., from which complete data-paths can be synthesized.

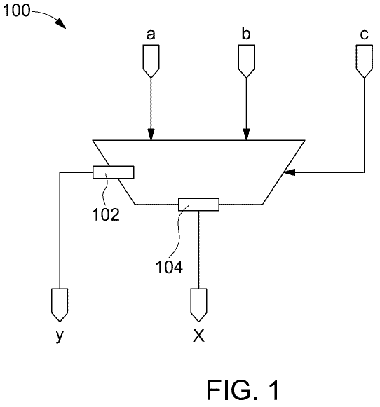

FIG. 1 illustrates a microcell of a microcell library, in accordance with an embodiment of the present disclosure. In an embodiment, a typical microcell 100 may implement a primitive logic and may have a uniform interface with three input operands a, b and c at an input interface and two output operands x and y at an output interface. In an embodiment, one or more of the three input operands and the two output operands may be enabled based on electric connection. Further, the two output operands x and y are latched to output registers 102 and 104 in a clock cycle.

In an embodiment, a library including a plurality of microcells 100 may be defined and hereinafter referred to as a microcell library. The each microcell 100 of the microcell library may be defined to implement partial arithmetic, bitwise-logic, shift or control-flow operations operation based on one or more of the three input operands a, b and c to generate the two output operands x and y.

In an embodiment, the three input operands a, b and c and each of the two output operands x and y may have a uniform pre-defined valency. In an embodiment, the uniform pre-defined valency may be selected from a pair (2-bits), a nibble (4-bits), a byte (8-bits), a half-word (16-bits), or an integer power of 2.

In an embodiment, the implementation of the logical operations or the partial arithmetic operations using one or more microcells from the library of microcells may be in a pipelined manner or an unpipelined manner.

In an embodiment, one or more of the plurality of microcells are combined for performing the partial arithmetic operation or the logical operation at a valency higher than the pre-defined valency.

In an embodiment, the microcell library may include, but not limited to, a logic microcell, a shift microcell, a mask microcell, a partial adder (padd) microcell, a partial subtractor (psub) microcell, a partial multiplier (pmlt) microcell, a compare microcell, a mux microcell, a demux microcell, etc.

In an embodiment, a data path element may be implemented using a plurality of microcells from the microcell library. The plurality of microcells may be connected in one or more topologies to perform an atomic operation on at least two atomic input data of a pre-defined bit-size. In an embodiment, the atomic operation may be split into a plurality of sub-atomic operations and the at least two atomic input data may be split into a plurality of sub-atomic data fragments. In an embodiment, each of the plurality of microcells may perform a sub-atomic operation from the plurality of subatomic operations on at least two sub-atomic data fragments from the plurality of subatomic data fragments to generate at least one partial sub-atomic output data. In an embodiment, the at least one partial sub-atomic output data may be generated based on a partial arithmetic operation, a shift operation, or a logical operation performed by each of the plurality of microcells in each clock-cycle.

In an embodiment, various data path elements may be implemented as combinatorial topologies using two or more microcells from the microcell library. In an embodiment, various data path elements may comprise, but not limited to, an adder data path element, a subtractor data path element, a multiplier data path element, a bitwise logic data path element, a bi-directional shifter data path element, a multiplexer data path element, a demultiplexer data path element, a comparator data path element, etc.

In an embodiment, a plurality of microcells may be connected in a serial topology by establishing at least one serial data path to output at least one partial subatomic output data from at least one preceding microcell of the plurality of microcells as input to at least one succeeding microcell of the plurality of microcells in a next clock-cycle.

In an embodiment, a plurality of microcells may be connected in a parallel topology by establishing at least two parallel data paths to output two partial subatomic output data each from two microcells from the plurality of microcells in parallel as input to at least two succeeding microcells of the plurality of microcells in the next clock clock-cycle.

In an embodiment, a plurality of microcells may be connected in a cascade topology by establishing at least two parallel data paths to output two partial subatomic output data each from at least one microcell from the plurality of microcells in parallel as input to at least one succeeding microcell of the plurality of microcells in a next clock-cycle.

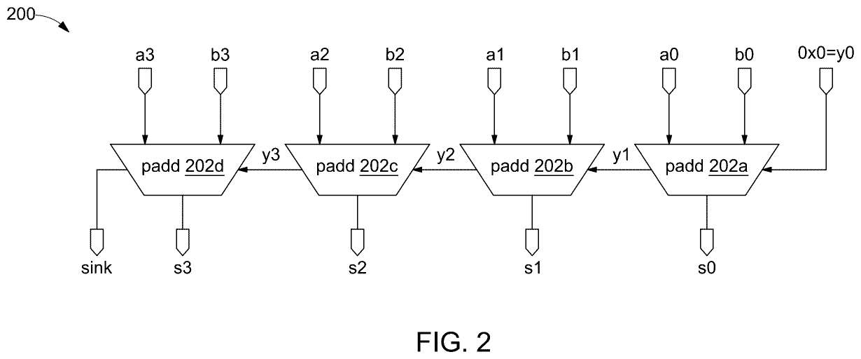

FIG. 2 illustrates an adder data path element 200, in accordance with an exemplary embodiment. The adder data path element 200 may perform the atomic operation of an addition on at least two atomic data a and b. In an embodiment, the adder data path element 200 may include at least two padd microcells 202a-d, each performing a partial addition operation. In an embodiment, the atomic data a and b may be of valencies of 2-bit, 4-bit, 8-bit or any other integer power of two bit. Each of the atomic data a and b may be split into sub-atomic data of minimum valency of 1 bit each. In an exemplary embodiment, the atomic data a and b may be split into subatomic data fragments a₀₋₃ and b₀₋₃ each specified as input operands to each of the padd or partial adder microcells 202a-d. The adder data path element 200 may have a latency of 4 clock cycles. But the throughput and the initial delay may be just 1 clock cycle each. This means that the adder data path element 200 is capable of producing results every clock cycle fragment by fragment while also consuming the operands every clock cycle fragment by fragment. On the contrary, in case of the state of-the-art pipelined parallel prefix designs, the throughput is 1 clock cycle but the latency and initial delay are both 5 clock cycles. Therefore, two data-dependent additions will necessarily take 10 clock cycles to complete, while in the case of subscalar designs they will complete in 5 cycles only. Moreover, the pipelined parallel prefix designs are composed of 14 logic blocks, while the subscalar designs are composed of only 4 logic blocks of comparable complexity which may result in high throughput-area gains. Even if the architecture of the proposed subscalar adder data path element 200 resembles simple carry propagate designs, their use cases are entirely different. The conventional carry propagate adders wait till all the sum bits are produced while the proposed subscalar designs move ahead to compute next sum fragment as soon as any earlier fragment has finished its computation. During this time the next higher significant fragment of the earlier computation is also taken up. This ensures a much higher throughput. Longer is the chain of such data dependent additions, higher are the throughput gains.

In an embodiment, the each of the padd or partial adder microcells 202a-d may be configured to perform a partial addition operation to output the sum of the three input operands a₀₋₃ and b₀₋₃ and c₀₋₃. The two output operands may represent a sum output s₀₋₃, and yₒᵤₜ₀₋₃ of the sum. In an embodiment, the three input ports of the three input operands a, b and c and the two output ports of the two output operands s and y are defined as:

$$c = {carry}_{in} \qquad ( 1 )$$

$$b = augend \qquad ( 2 )$$

$$a = addend \qquad ( 3 )$$

$$s = sum \qquad ( 4 )$$

$$y = {carry}_{out} \qquad ( 5 )$$

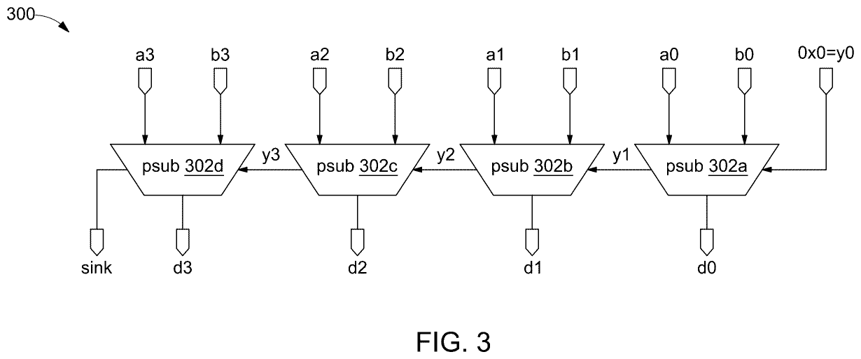

FIG. 3 illustrates a subtractor data path element 300, in accordance with an exemplary embodiment. The subtractor data path element 300 to perform the atomic operation of a subtraction on the at least two atomic data a and b. In an embodiment, the subtractor data path element 300 may include at least two microcells 302a-d, each performing a partial subtraction operation. In an embodiment, the atomic data a and b may be of valencies of 2-bit or more. Each of the atomic data a and b may be split into sub-atomic data of minimum valency of 1 bit each. In an exemplary embodiment, the atomic data a and b may be split into subatomic data fragments a₀₋₃ and b₀₋₃ each inputted as input operands to each of the psub or partial subtractor microcells 302a-d. The subtractor data path element 300 may have a latency of 4 clock cycles. But the throughput and the initial delay may be just 1 clock cycle each. This means that the subtractor data path element 300 is capable of producing results every clock cycle fragment by fragment while also consuming the operands every clock cycle fragment by fragment. On the contrary, in case of the state-of-the-art pipelined parallel prefix designs, the throughput is 1 clock cycle but the latency and initial delay are both 5 clock cycles. Therefore, two data-dependent subtractions will necessarily take 10 clock cycles to complete, while in the case of subscalar designs they will complete in 5 cycles only. Moreover, the pipelined parallel prefix designs are composed of 14 logic blocks, while the subscalar designs are composed of only 4 logic blocks of comparable complexity which may result in high throughput-area gains.

Even if the architecture of the proposed subscalar subtractor resembles simple borrow propagate designs, their use cases are entirely different. The conventional borrow propagate subtractors wait till all the difference bits are produced while the proposed subscalar designs move ahead to compute next borrow fragment as soon as any earlier fragment has finished its computation. During this time the next higher significant fragment of the earlier computation is also taken up. This ensures a much higher throughput. Longer is the chain of such data dependent subtractions, higher are the throughput gains.

In an embodiment, each of the psub or partial subtractor microcells 302a-d may be configured to perform a partial subtraction operation to output the difference by subtracting a second input operand b₀₋₃ and a third input operand c₀₋₃ from a first input operand a₀₋₃, wherein a first output operand d₀₋₃ may represent the difference output in 2's compliment form, and the second output operand c₀₋₃ may represent the borrowₒᵤₜ of the difference output. In an embodiment, the three input ports of the three input operands a, b and c and the two output ports of the two output operands d and y are connected as:

$$c = {borrow}_{in} \qquad ( 6 )$$

$$b = subtrahend \qquad ( 7 )$$

$$a = minuend \qquad ( 8 )$$

$$d = difference \qquad ( 9 )$$

$$y = {borrow}_{out} \qquad ( 10 )$$

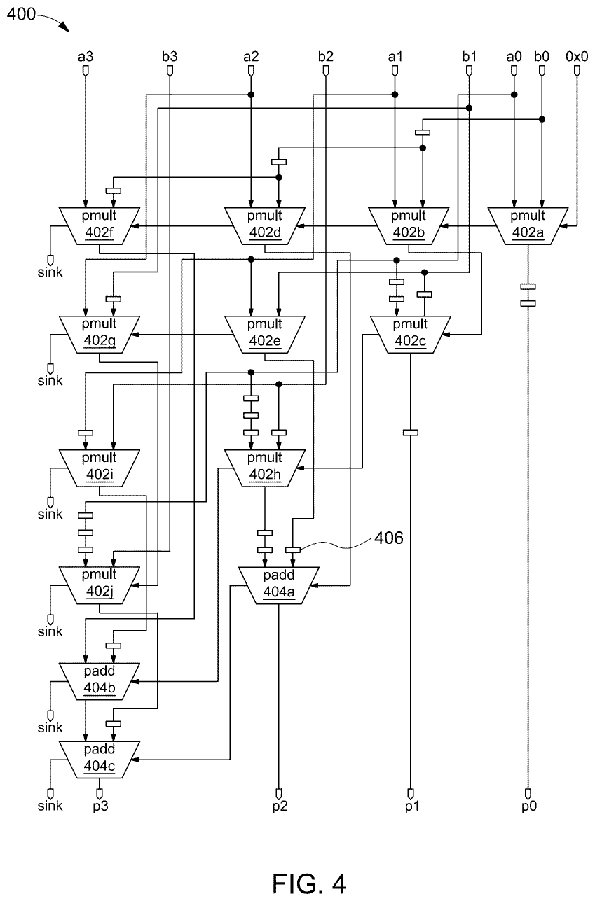

FIG. 4 illustrates a multiplier data path element 400, in accordance with an exemplary embodiment. The multiplier data path element 400 is configured to perform the atomic operation of a multiplication on the at least two atomic data a and b. In an embodiment, the multiplier data path element 400 may comprise at least four microcells including partial multiplier microcells 402a-j and partial adder microcells 404a-c. The partial multiplier microcells 402a-j may perform a partial multiply-add operation and the partial adder microcells 404a-c may perform a partial addition operation. The subscalar multiplier architecture of multiplier data path element 400 is presented in FIG. 4. The design is a little irregular in a couple of least significant blocks but is capable of achieving latency of 6 cycles, throughput of 1 cycle, and initial delay of 3 cycles and uses 13 blocks which are all better figures than any conventional design of multipliers. The solid rectangles 406 in the architecture presented in FIG. 4 are synchronizing registers and the microcell sink indicates that the respective port is left unconnected. The data-path element 400 may be commonly used in signal processing applications and can be synthesized with a cascade connection of partial multiplier microcells 402a-j and partial adder microcells 404a-c. In case of subscalar designs one can process successive samples every 3 cycles while in case of conventional pipelined designs can process them with a speed of 8 cycles per sample.

In an embodiment, the partial multiply-add microcell 402a-j may be configured to perform a partial multiply-add operation to output a product of a first input operand a₀₋₃ and a second input operand b₀₋₃ added to a third input operand c₀₋₃. In an embodiment, a first output operand p₀₋₃ may represent a lower half significant bit of the output, and a second output operand p₄₋₇ may represent an upper half significant bits of the output. In an embodiment, the three input ports of the three input operands a₀₋₃, b₀₋₃ and c₀₋₃ and the two output ports of the two output operands p₀₋₃ and p₄₋₇ are connected as:

$$c = augend \qquad ( 11 )$$

$$b = multiplier \qquad ( 12 )$$

$$a = multiplicand \qquad ( 13 )$$

$${p}_{0 - 3} = {product}_{low} \qquad ( 14 )$$

$${p}_{4 - 7} = {product}_{high} \qquad ( 15 )$$

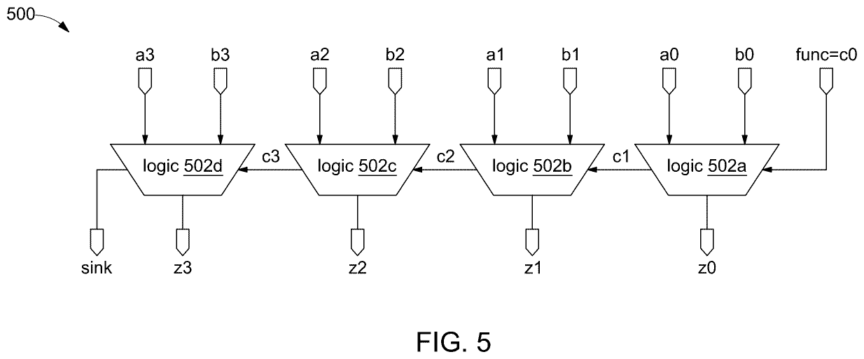

FIG. 5 illustrates a bitwise logic data path element 500, in accordance with an embodiment of the present disclosure. The bitwise logic data path element 500 may perform the atomic operation of a bitwise logic on the at least two atomic data a and b. In an embodiment, the bitwise logic data path element 500 may comprise at least two or more logic microcells 502a-d each performing a logic operation. In an embodiment, the logic operation may be a bit-wise operation or a binary operation. The bitwise logic data path element 500 may implement bit-wise logic operation in subscalar computational methodology and can be implemented as a cascade connection of logic microcells 502a-d and shown in FIG. 5. The bit-wise logic operation to be computed is based on the third input c₀₋₃ to the logic microcells 502a-d which flows through the design cycle by cycle to ensure that the inputs to and the output from this data-path element follows the subscalar wave shape (staircase). It may achieve throughput and initial delay of 1 cycle and a latency of 4 cycles while it is composed of 4 logic microcells 502a-d.

In an embodiment, each of the logic microcells 502a-d of the microcell library may be configured to perform a bit-wise logic operation. In an embodiment, for performing the bit-wise logic operation, each of the logic microcells 502a-d may be configured to perform a bit-wise logic operation NOT on at least one of a first input operand a₀₋₃ or other binary logic operations like AND, OR or Ex-OR on a first input operand a₀₋₃, a second input operand b₀₋₃ based on a third input operand c₀₋₃ to output a first output operand z₀₋₃ of the two output operands based on the bit-wise logic operation and a second output operand y₀₋₃ of the two output operands z and y as a copy of the third input operand c₀₋₃ as the output y in the next clock cycle which are latched to a register. In an embodiment, the output z₀₋₃ is also latched to a register.

In an embodiment, each of the logic microcells 502a-d may perform a bit-wise logic operation such as, but not limited to, a complement operation, AND operation, OR operation, EX-OR operation, etc.

In an embodiment, each of the logic microcells 502a-d may perform a complement operation by complementing one of the first input operand a₀₋₃, in case the third input operand c₀₋₃ is Boolean value of 0. Further, the logic microcell 502a-d may perform an AND operation of the first input operand a₀₋₃ and a second input operand b₀₋₃, in case the third input operand c₀₋₃ is Boolean value of 1. Further, the logic microcell 502a-d may perform an OR operation of the first input operand a₀₋₃ and a second input operand b₀₋₃, in case the third input operand c₀₋₃ is Boolean value of 2. Further, the logic microcell 502a-d may perform an EX-OR operation of the first input operand a₀₋₃ and a second input operand b₀₋₃, in case the third input operand c₀₋₃ is Boolean value of 3.

In an embodiment, the three input operands a₀₋₃, b₀₋₃ and c₀₋₃ of the logic microcell 502a-d may be represented by the equations:

$$a = data\_in \_ 1 \qquad ( 16 )$$

$$b = data\_in \_ 0 \qquad ( 17 )$$

$$c = func \qquad ( 18 )$$

In an exemplary embodiment, data_in_0 represents the 2-bit input as first input operand and data_in_1 represents the 2-bit input as second input operand and func represents the 2-bit input as third input operand depicting the type of bit-wise operation to be performed on the input operands a₀₋₃ and b₀₋₃.

In an embodiment, the logic microcell may implement bit-wise logical functions NOT, AND, OR and Ex-OR of the input pairs connected to a₀₋₃ and b₀₋₃ depending upon whether c₀₋₃ is 00, 01, 10 or 11 respectively.

In an embodiment, the two output operands z₀₋₃ and y of the logic microcell 502a-d may be connected as represented by the equations:

$$z = data\_out \_ 1 \qquad ( 19 )$$

$$y = func \qquad ( 20 )$$

The computation of x for a 2-bit logic micro-cell is based on the following logic:

$$if ( func = 0 ) , z = {( data\_in \_ 0 )}^{′} \qquad ( 21 )$$

$$else if ( func = 1 ) , z = data\_in \_ 1 \& data\_in \_ 0 \qquad ( 22 )$$

$$else if ( func = 2 ) , z = data\_in \_ 1 ‖ data\_in \_ 0 \qquad ( 23 )$$

$$else if ( func = 3 ) , z = data\_in \_ 1 ⊕ data\_in \_ 0 \qquad ( 24 )$$

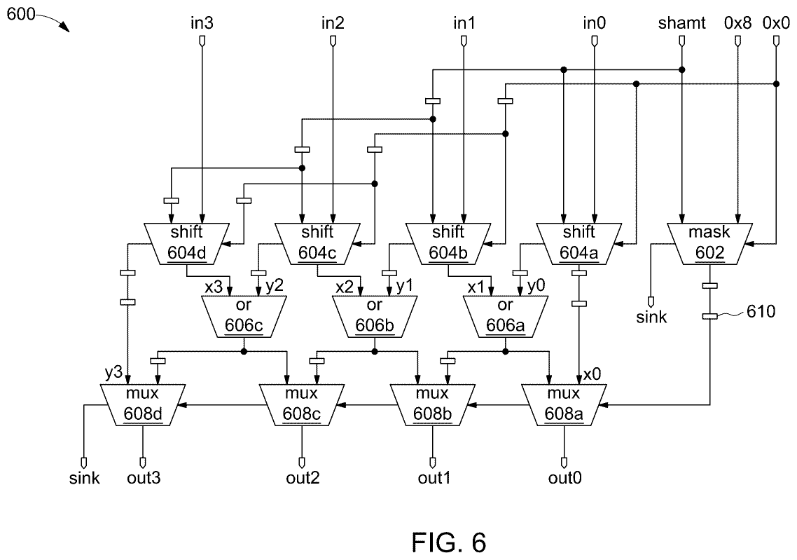

FIG. 6 illustrates a bi-directional shifter data path element 600, in accordance with an embodiment of the present disclosure. The bi-directional shifter data path element 600 may perform the atomic operation of a bi-directional shift of the at least two sub-atomic data. In an embodiment, the bi-directional shifter may comprise at least one mask microcell 602 performing a mask operation, at least two shift microcells 604a-d each performing a bit-wise left shift operation, and at least one OR microcell 606a-c performing an OR operation.

In an embodiment, the one of the input of the mask microcell 602 shamt may provide the number of bits to be shifted in the left or the right direction. In an embodiment, if the value of shamt is positive, the bi-directional shifter achieves left shift, while if it is negative and specified in 2's complement form, it achieves right shift.

The shift microcells 604a-d of the microcell library may be configured to perform a left bitwise shift operation on one of a second input operand in₀₋₃ based on a number of bit-positions specified by the third input operand shamt from the three input operands. In an embodiment, one input operand is disconnected or fed as 0 to mask microcell 602 and shift microcells 604a-d.

The output x₀₋₃ represents the lower half bits of the shifted input and the output y₀₋₃ represents the upper half bits of the shifted input. In an embodiment, the lower half bits are padded with zeroes in the right bit positions and the upper half bits are padded with zeroes in the left bit positions based on the shamt value.

The outputs from adjacent shift microcells 604a-d are then logically “ORed” using OR microcells 606a-c each performing a logical OR operation on the outputs of the consecutive shift microcells 604a-d and relevant shifted outputs are finally selected by using mux microcells 608a-d each performing a multiplexing operation by selecting one of the two inputs as its output. This novel scheme works well even for higher valency designs. The only constraint is that the shift amount cannot be more than the valency of implementation. This, however, is not a constraint in hardware realizations as any remaining shifting can be trivially achieved by rewiring or barrel shifters 604a-d. It achieves a throughput of 1 cycle, a latency of 7 cycles, and an initial delay of 4 cycles.

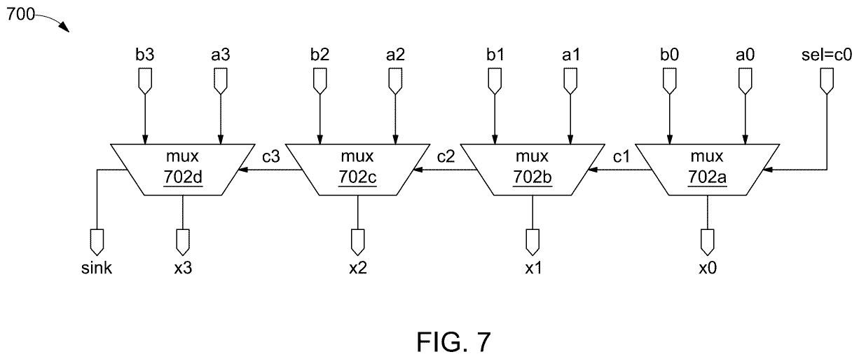

FIG. 7 illustrates a multiplexer data path element 700, in accordance with an embodiment of the present disclosure. The multiplexer data path element 700 may perform the atomic operation of selecting one of the inputs from the at least two atomic data. In an embodiment, the multiplexer data path element 700 may comprise at least two mux microcells 702a-d implemented in cascade topology, each performing a multiplexing operation. All of the mux microcells 702a-d may achieve throughput and initial delay of 1 cycle and latency of 5, 4, and 4 cycles respectively.

Each of the mux microcells 702a-d of the microcell library may be configured to perform a multiplexing operation to select first output operand x₀₋₃ equal to a first input operand a₀₋₃ from the three input operands a₀₋₃, b₀₋₃ and c₀₋₃ in case the third input operand c₀₋₃ is equal to “0”. In an embodiment, each of the mux microcell 702ad may be configured to perform a multiplexing operation to select at first output operand x₀₋₃ equal to a second input operand b₀₋₃ from the three input operands a₀₋₃, b₀₋₃ and c₀₋₃ in case the third input operand c₀₋₃ is equal to “3”. In an embodiment, the mux microcell 702a-d may be configured to replicate a third input operand c₀₋₃ from the three input operands a, b and c at the second output operand y₀₋₃. In an embodiment, the three input ports of the three input operands a, b and c and the two output ports x and y are connected as:

$$c = select \qquad ( 30 )$$

$$b = data\_in \_ 0 \qquad ( 31 )$$

$$a = data\_in \_ 1 \qquad ( 32 )$$

$$x = data\_out \qquad ( 33 )$$

$$y = select \qquad ( 34 )$$

In an exemplary implementation of a 2-bit mux microcell 702a-d may be represented by the following logic:

$$if ( c = 0 ) , x = b \qquad ( 35 )$$

$$else if ( c = 3 ) , x = a \qquad ( 36 )$$

$$y = c \qquad ( 37 )$$

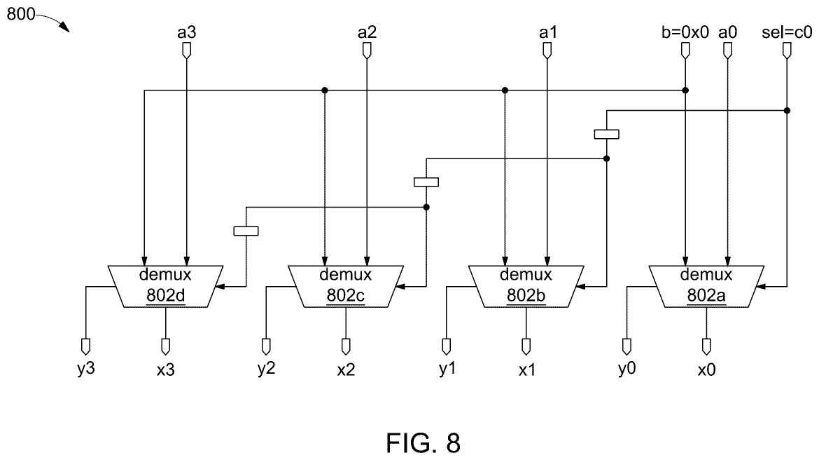

FIG. 8 illustrates a demultiplexer data path element 800, in accordance with an embodiment of the present disclosure. The demultiplexer data path element 800 may perform the atomic operation of steering the input a₀₋₃ to one of two output paths x₀₋₃ and y₀₋₃. In an embodiment, the demultiplexer data path element 800 may comprise at least two demux microcells 802a-d implemented in cascade topology and each performing a demultiplexing operation.

In an embodiment, each of the demux microcells 802a-d of the microcell library may be configured to perform a demultiplexing operation to either output a first output operand x₀₋₃ equal to input operand a₀₋₃ in case the third input operand c₀₋₃ is equal to “0”. In an embodiment, each of the demux microcells 802a-d may be configured to output the second output operand y₀₋₃ equal to the input operand a₀₋₃ in case the third input operand c₀₋₃ is equal to “3”. In an embodiment, the second input operand b is left unconnected. In an embodiment, the three input ports of the two input operands b and c and the two output ports x and y are connected as:

$$c = select \qquad ( 38 )$$

$$a = data\_in \qquad ( 39 )$$

$$x = data\_in \_ 0 \qquad ( 40 )$$

$$y = data\_out \_ 1 \qquad ( 41 )$$

In an exemplary implementation of a 2-bit demux microcell 802a-d the functional semantics may be represented by the following logic:

$$if ( c = 0 ) , x = a \qquad ( 42 )$$

$$else if ( c = 3 ) , y = a \qquad ( 43 )$$

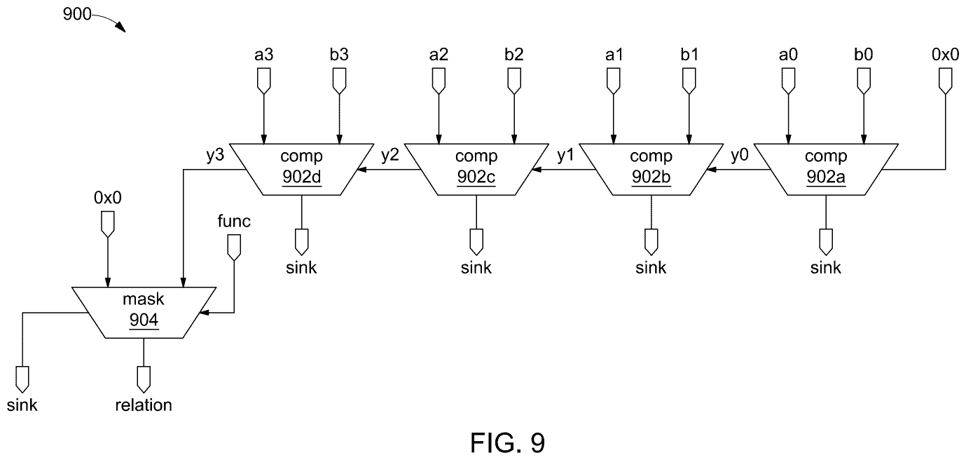

FIG. 9 illustrates a comparator data path element 900, in accordance with an embodiment of the present disclosure. The comparator data path element 900 may perform the atomic operation of compare on the at least two atomic data a and b. In an embodiment, the comparator data path element 900 may comprise at least two compare microcells 902a-d connected to each other in cascade topology and each configured to perform a compare operation. Further, the comparator data path element 900 may include one mask microcell 904 which may be configured to perform a mask operation. The output of the last compare microcells 902a-d connected in cascade topology is masked as per the input func to receive the final output relation of the comparator data path element 900.

In an embodiment, the connection shown in FIG. 9 of the compare microcells 902a-d and mask microcell 904 may perform a compare operation to output as “0” in case a first input operand a is equal to a second input operand b, or output as “1” in case a first input operand a is greater than a second input operand b, or output as “2” in case a first input operand a is less than a second input operand b.

In an embodiment, each of the compare microcells 902a-d may be configured to output the second output operand y₀₋₃ as “1” in case the first input operand a₀₋₃ is greater than the second input operand b₀₋₃ or in case the first input operand a₀₋₃ is equal to the second input operand b₀₋₃ and the third input operand c₀₋₃ is equal to “1”. In an embodiment, the compare microcell 902a-d may be configured to output the second output operand y₀₋₃ as “2” in case the first input operand a₀₋₃ is less than the second input operand b₀₋₃ or in case the first input operand a₀₋₃ is equal to the second input operand b₀₋₃ and the third input operand c₀₋₃ is equal to “2”. In an embodiment, the three input ports of the three input operands a, b and c and one output port y are connected as:

$$c = compare\_so \_far \qquad ( 44 )$$

$$b = data\_in \_ 0 \qquad ( 45 )$$

$$a = data\_in \_ 1 \qquad ( 46 )$$

$$y = {compatison}_{out} \qquad ( 47 )$$

In an embodiment, according to an exemplary implementation of a 2-bit compare microcell 902a-d the computation of y₀₋₃ for 2-bit input of a₀₋₃, b₀₋₃ and c₀₋₃ is based on functional semantic represented by the following logic:

$$if ( b = a \& c = 0 ) , y = 0 \qquad ( 48 )$$

$$else if ( b > a \vert b = a \& c = 1 ) , y = 1 \qquad ( 49 )$$

$$else if ( b < a \vert b = a \& c = 2 ) , y = 2 \qquad ( 50 )$$

In an embodiment, each of the two outputs of the microcells of the microcell library may be latched to registers which may be synchronized with respect to clock cycle.

Further, the data path elements 200, 300, 400, 500, 600, 700, 800 and 900 may be implemented for valency of, but not limited to, 2-bits, 4-bits, a byte, a half-word (16-bits), a word (32 bits) and so on to create combinatorial topologies comprising microcells 100 for various valencies.

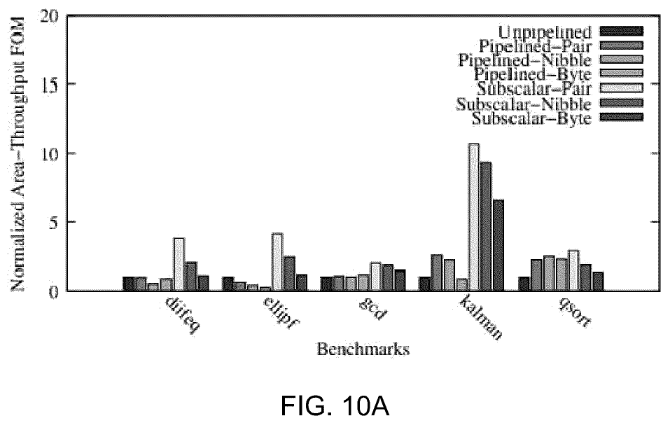

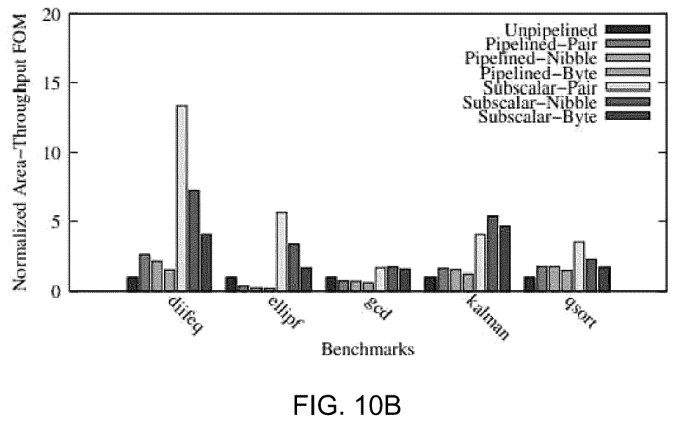

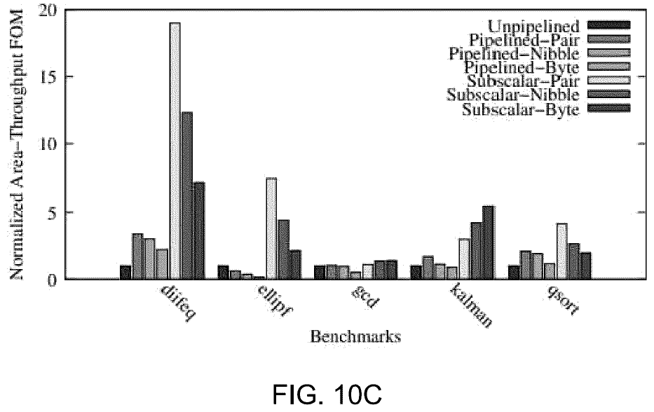

It is worth mentioning that the latencies of data-path elements lose their significance in subscalar designs and are thus irrelevant when used in larger algorithmic data-paths. The throughput for all the subscalar data-path elements 200, 300, 400, 500, 600, 700, 800 and 900 described above are 1 cycle each which helps in achieving overall throughput of 1 cycle per instruction for the entire data-path irrespective of the fact whether the instructions have any data dependence or not. The initial delay is not much and gets amortized over long runs of instructions. In the case of dependent operations and in the case of loops, higher initial delay has a detrimental effect. This does not impact the overall gains too much as evident in the results presented in FIG. 10A, FIG. 10B, and FIG. 10C. All the circuits, however, consume much less area and consequently much less power as compared to their state-of-the art high-speed implementations. The speedups are negligibly small and even negative in some cases of super pipelined instances. This is due to the data dependencies exhibited by the benchmark programs evaluated. Forwarding (bypassing) resolves the true data dependencies in the standard baseline 5-stage in-order-issue processor considered in this thesis. However, in cases of its super pipelined version, the data dependent instruction has to suffer stalls till the instruction on which it is dependent produces its result. This can be prohibitively large. At the same time the Silicon area needed for realization of super pipelined versions are higher due to a couple of reasons. First of all many more pipelining registers are needed. Apart from this, the hazard detection and resolution hardware is quadratically more complex. The area throughput figure-of-merit is thus even worse. The subscalar versions do not suffer from this bottleneck. Evidently, the next data dependent instruction can initiate its execution in the very next cycle, even if the earlier instruction has not produced its complete result. This is achieved because the earlier instruction has at least produced the least significant data fragment of the result upon which is consumed by the least significant data fragment of the data later instruction. This results in phenomenal speedups. Moreover, the hazard detection and resolution hardware needed in their case is exactly same as that of the baseline processor. At the same time, the implementation logic for all the data-path elements is much less Silicon intensive. This gets reflected in much larger area-throughput figure-of-merit.

The area estimates may be reduced by a factor of almost two and a half when implemented using subscalar computing methodology as disclosed in details in the concurrently filed Indian patent application titled “System and Method For Implementation of Computational Logic Using Digital VLSI Systems” and “Microcell Library For Implementation Of Computational Logic Using Digital VISI Systems” and the IEEE paper titled “Novel VLSI Architectures and Micro-Cell Libraries for Subscalar Computations” each incorporated herein in entirety by reference.

Accordingly, the implementation of computational logic using subscalar methodology may preserve the data width and by processing smaller fragments of full width data gainfully to reduce the complexities either in space, or time, or both.

The subscalar computational logic implements an overlapped execution of data-dependent or independent plurality of atomic operations. A subscalar computing unit (not shown) may perform various atomic operations which may be based on one or more logical computational logics such as addition, subtraction, multiplication, shift, mux, de-mux, etc. implemented using microcell library of the present disclosure to output a resultant data. The throughput achieved in the subscalar computation methodology is approximately five-time units per iteration which is comparatively lesser than the throughput achieved using conventional computation methodologies which also have throughput with latency of up to nine time units per iteration.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate logic primitives (or partial processing units) of various data-path elements in the context of the present disclosure may be implemented as, but not limited to, microcells, discrete components, reconfigurable look up tables or ROM cells, etc. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention may not be limited only by the claims. Additionally, although a feature may appear to be described in connection with embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category as claimed in claims does not imply a limitation to this category, but rather the feature may be equally applicable to other claim categories, as appropriate.

What is claimed is:

1. A data path element, comprising:
a plurality of logic primitives connected in one or more topologies to perform an atomic operation on at least two atomic input data of a pre-defined bit-size, wherein
the atomic operation is split into a plurality of sub-atomic operations and the at least two atomic input data are split into a plurality of subatomic data fragments, wherein each of the plurality of logic primitives perform a sub-atomic operation from the plurality of sub-atomic operations on at least two sub-atomic data fragments from the plurality of sub-atomic data fragments to generate at least one partial sub-atomic output data, and wherein the at least one partial sub-atomic output data is generated based on a partial arithmetic operation, a shift operation, or a logical operation performed by each of the plurality of logic primitives in each clock-cycle.

2. The data-path element as claimed in claim 1, wherein the one or more topologies comprises a serial topology, a parallel topology and/or a cascade topology.

3. The data-path element as claimed in claim 2, wherein the plurality of logic primitives are connected in a serial topology by establishing at least one serial data path to output at least one partial sub-atomic output data from at least one preceding logic primitive of the plurality of logic primitives as input to at least one succeeding logic primitive of the plurality of logic primitives in a next clock-cycle.

4. The data-path element as claimed in claim 2, wherein the plurality of logic primitives are connected in a parallel topology by establishing at least two parallel data paths to output two partial sub-atomic output data each from two logic primitives from the plurality of logic primitives in parallel as input to at least two succeeding logic primitives of the plurality of logic primitives in the next clock clock-cycle.

5. The data-path element as claimed in claim 2, wherein the plurality of logic primitives are connected in a cascade topology by establishing at least two parallel data paths to output two partial sub-atomic output data each from at least one logic primitive from the plurality of logic primitives in parallel as input to at least one succeeding logic primitive of the plurality of logic primitives in a next clock-cycle.

6. The data-path element as claimed in claim 1, wherein each of the plurality of logic primitives are configured to perform one of a logic operation, a shift operation, a mask operation, a partial addition operation, a partial subtraction operation, a partial multiplication operation, a compare operation, a multiplexing operation, or a demultiplexing operation.

7. The data-path element as claimed in claim 1, is configured as an adder data path element to perform the atomic operation of an addition on the at least two atomic data, wherein the adder data path element comprises at least two logic primitives, each performing a partial addition operation.

8. The data-path element as claimed in claim 1, is configured as a subtractor data path element to perform the atomic operation of a subtraction on the at least two atomic data, wherein the subtractor data path element comprises at least two logic primitives, each performing a partial subtraction operation.

9. The data-path element as claimed in claim 1, is configured as a multiplier data path element to perform the atomic operation of a multiplication on the at least two atomic data, wherein the multiplier data path element comprises at least four logic primitives, and wherein the at least four logic primitives are configured to perform a partial multiply-add operation and/or a partial addition operation.

10. The data-path element as claimed in claim 1, is configured as a bitwise logic data path element to perform the atomic operation of a bitwise logic on the at least two atomic data, wherein the bitwise logic data path element comprises at least two or more logic primitives performing a logic operation.

11. The data-path element as claimed in claim 1, is configured as a bi-directional shifter to perform the atomic operation of a bi-directional bit-wise shift of the at least two sub-atomic data, wherein the bi-directional shifter comprises:
at least one logic primitive performing a mask operation, at least two logic primitives each performing a left shift operation, at least one logic primitive performing an OR operation, and at least one logic primitive performing a multiplexing operation.

12. The data-path element as claimed in claim 1, is configured as a multiplexer data path element to perform the atomic operation of selecting one of the inputs from the at least two atomic data, wherein the multiplexer data path element comprises at least two mux logic primitives, each performing a multiplexing operation.

13. The data-path element as claimed in claim 1, is configured as a demultiplexer data path element to perform the atomic operation of steering the input to the at least one of two output paths, wherein the demultiplexer data path element comprises at least two demux logic primitives, each performing a demultiplexing operation.

14. The data-path element as claimed in claim 1, is configured as a comparator data path element to perform the atomic operation of compare on the at least two atomic data, wherein the comparator data path element comprises:
at least two compare logic primitives, each configured to perform a compare operation, and one mask logic primitive configured to perform a mask operation.
